(19) United States
(12) Patent Application Publication
(10) Pub. No.: US 2024/0004200 A1
(43) Pub. Date: Jan. 4, 2024

(54) VIRTUAL IMAGE DISPLAY DEVICE

(71) Applicant: SEIKO EPSON CORPORATION, Tokyo (JP)

(72) Inventor: Masayuki TAKAGI, Azumino-shi (JP)

(73) Assignee: SEIKO EPSON CORPORATION, Tokyo (JP)

(21) Appl. No.: 18/215,634

(22) Filed: Jun. 28, 2023

(30) Foreign Application Priority Data
Jun. 29, 2022 (JP) 2022-104317

(51) Int. Cl. G02B 27/01; G02B 27/28

(52) U.S. Cl. CPC G02B 27/0172; G02B 27/283

(57) ABSTRACT

A virtual image display device includes a display element that is an image light generation device, a projection optical system on which image light from the display element is incident, and a partially transmissive mirror configured to partially reflect the image light from the projection optical system toward a pupil position, and a transmissive polarizer is disposed outside the partially transmissive mirror.

The present application is based on, and claims priority from JP Application Serial Number 2022-104317, filed Jun. 29, 2022, the disclosure of which is hereby incorporated by reference herein in its entirety.

### BACKGROUND

### 1. Technical Field

The present disclosure relates to a virtual image display device that enables observation of a virtual image and more particularly to a virtual image display device including a partially transmissive mirror.

### 2. Related Art

In some virtual image display devices, an optical member having optical transparency is disposed in front of eyes so that image light and outside light can be simultaneously observed. For example, JP-A-2020-008749 discloses a virtual image display device including a transmissive inclined mirror reflecting image light from an image light generation device, and a concave transmissive mirror reflecting the image light that has been reflected by the transmissive inclined mirror toward the transmissive inclined mirror, in which an absorber layer is disposed outside the concave transmissive mirror.

According to JP-A-2020-008749 described above, the absorber layer can suppress a situation in which an image being displayed can be seen from the outside. However, since various light sources on the outside are reflected on the surface of the spectacle-like concave transmissive mirror, an outside light pattern is projected on the convex surface of the concave transmissive mirror and is seen by an outside person in a glittered manner.

### SUMMARY

A virtual image display device according to an aspect of the present disclosure includes an image light generation device, a projection optical system on which image light from the image light generation device is incident, and a partially transmissive mirror configured to partially reflect the image light from the projection optical system toward a pupil position, wherein a transmissive polarizer is disposed outside the partially transmissive mirror.

### BRIEF DESCRIPTION OF THE DRAWINGS

FIG. 1 is an external perspective view for describing a mounted state of a virtual image display device according to a first embodiment.

FIG. 2 is a side cross-sectional view for describing a structure of the virtual image display device.

FIG. 3 is a partially enlarged cross-sectional view for describing a periphery of a partially transmissive mirror and a cover member.

FIG. 4 is a conceptual diagram for describing a polarization state of a light beam in more detail.

FIG. 5 is a cross-sectional view for describing a modified example of a see-through mirror.

FIG. 6 is a cross-sectional view for describing a modified example of a polarizing filter.

FIG. 7 is a side cross-sectional view for describing a structure of a virtual image display device according to a second embodiment.

FIG. 8 is a partially enlarged cross-sectional view for describing a periphery of a partially transmissive mirror.

FIG. 9 is a side cross-sectional view for describing a structure of a virtual image display device according to a third embodiment.

FIG. 10 is a partially enlarged cross-sectional view for describing a periphery of a partially transmissive mirror.

FIG. 11 is a conceptual diagram for describing a polarization state of a light beam in more detail.

FIG. 12 is a diagram for describing a modified example of a see-through mirror illustrated in FIG. 10 and the like.

FIG. 13 is a side cross-sectional view for describing a virtual image display device according to a fourth embodiment.

FIG. 14 is a side cross-sectional view for describing a virtual image display device according to a modified example.

FIG. 15 is a side cross-sectional view for describing a virtual image display device according to a fifth embodiment.

### DESCRIPTION OF EXEMPLARY EMBODIMENTS

### First Embodiment

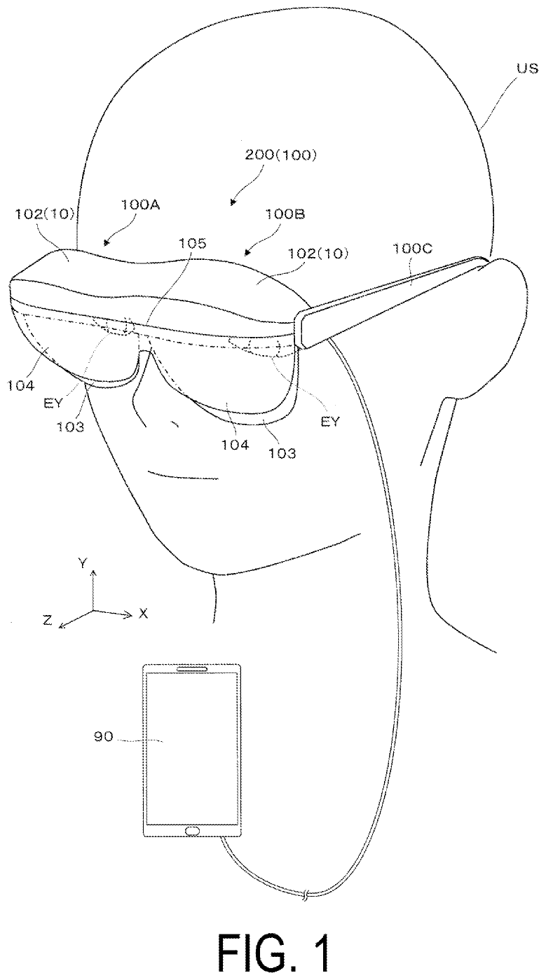

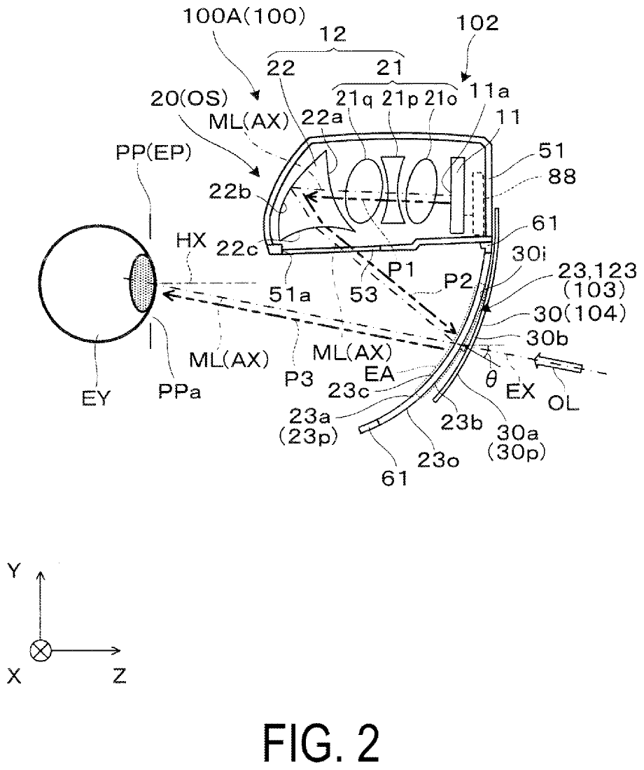

A virtual image display device according to a first embodiment of the present disclosure will be described below with reference to FIGS. 1, 2, and the like.

FIG. 1 is a diagram for describing a mounted state of a head-mounted display (hereinafter, also referred to as “HMD”) 200, and the HMD 200 allows an observer or wearer US who wears the HMD 200 to recognize an image as a virtual image. In FIG. 1 and the like, X, Y, and Z are orthogonal coordinates, the +X direction corresponds to a transverse direction in which both eyes EY of the observer or wearer US wearing the HMD 200 or a virtual image display device 100 are located side by side, the +Y direction corresponds to an upward direction orthogonal to the transverse direction in which both eyes EY of the wearer US are located side by side, and the +Z direction corresponds to a forward or front direction of the wearer US. The +Y directions are parallel to the vertical axis or the vertical direction.

The HMD 200 includes a first display device 100A for the right eye, a second display device 100B for the left eye, a pair of temple type support devices 100C that support the display devices 100A and 100B, and a user terminal 90 that is an information terminal. The first display device 100A functions as a virtual image display device by itself and includes a display driving unit 102 disposed at an upper portion thereof, a combiner 103 that has a spectacle lens shape and covers the front of the eye, and a cover member 104 that covers the combiner 103 from the front. Similarly, the second display device 100B functions as a virtual image display device by itself and includes a display driving unit 102 disposed at an upper portion thereof, a combiner 103 that has a spectacle lens shape and covers the front of the eye, and a cover member 104 that covers the combiner 103. A combination of the pair of cover members 104 is referred to as a shade 105. The shade 105 is an integrated member and is attachable to and detachable from the display driving units 102 via a support mechanism (not illustrated). Each support device 100C is a mounting member mounted on the head of the wearer US and supports the upper end side of the combiner 103 via the display driving unit 102. The first display device 100A and the second display device 100B are devices the left and the right of which are optically inverted, and a detailed description of the second display device 100B will be omitted.

FIG. 2 is a side cross-sectional view for describing an optical structure of the first display device 100A. The first display device 100A includes a display element 11, an imaging optical system 20, a polarizing filter 30, and a display control device 88. The imaging optical system 20 includes a projection lens 21, a prism mirror 22, and a see-through mirror 23. In the imaging optical system 20, the projection lens 21 and the prism mirror 22 function as a projection optical system 12 on which image light ML from the display element 11 that is an image light generation device is incident, and the see-through mirror 23 functions as a partially transmissive mirror 123 partially reflecting the image light ML emitted from the projection optical system 12 toward a pupil position PP or an eye EY. The projection lens 21 and the prism mirror 22 constituting the projection optical system 12 correspond to a first optical member and a second optical member on which video light or image light ML is incident, respectively. The display element 11, the projection lens 21, and the prism mirror 22 correspond to a part of the display driving unit 102 illustrated in FIG. 1, and the see-through mirror 23 corresponds to the combiner 103 illustrated in FIG. 1. The see-through mirror 23 has an outer shape that is convex outward, and the side of the see-through mirror 23 facing the outside is partially covered with the polarizing filter 30 separately provided. The projection lens 21 and the prism mirror 22 constituting the projection optical system 12, as well as the display element 11, are fixed in a case 51 in a state of being mutually aligned. The polarizing filter 30 corresponds to the cover member 104 illustrated in FIG. 1. The case 51 is a housing or a support member, is formed of a light-shielding material, and supports the display control device 88 operating the display element 11. The case 51 includes an opening 51a, and the opening 51a is closed by a light-transmissive plate 53. The light-transmissive plate 53 enables the projection optical system 12 to emit the image light ML toward the outside of the case 51 and suppresses entering of dust and moisture to the inside of the case 51.

In the first display device 100A, the display element 11 is an image light generation device that emits light by itself. The display element 11 is, for example, an organic electro-luminescence (EL) display and forms a color still image or moving image on a two-dimensional display surface 11a. The display element 11 that is the image light generation device is driven by the display control device 88 that is a control unit to perform a display operation. The display element 11 is not limited to the organic EL display, and can be replaced with a display device using inorganic EL, an organic LED, an LED array, a laser array, a quantum dot light emission element, or the like. The display element 11 is not limited to an image light generation device that emits light by itself and may include an LCD or another light modulation element and form an image by illuminating the light modulation element by a light source such as a backlight. As the display element 11, a liquid crystal on silicon (LCoS) (trade name), a digital micro-mirror device, or the like may be used instead of an LCD.

When the display element 11 is, for example, an LCD, the image light ML emitted from the display element 11 is typically polarized light. As will be described later, in the first embodiment, since a reflective polarizing film 23a of the see-through mirror 23 reflects s-polarized light, the image light ML emitted from the display element 11 needs to be s-polarized light or needs to include s-polarized light.

The imaging optical system 20 is an off-axis optical system OS due to the see-through mirror 23 being a concave mirror. In the first embodiment, the projection lens 21, the prism mirror 22, and the see-through mirror 23 are disposed to be non-axially symmetrical and have an optical surface that is non-axisymmetric. In this imaging optical system 20, an optical axis AX is bent in the off-axis plane parallel to the YZ plane, so that the optical elements 21, 22, and 23 are arranged along the off-axis plane. Specifically, in the off-axis plane parallel to the YZ plane, an optical path P1 from the projection lens 21 to an inner reflection surface 22b, an optical path P2 from the inner reflection surface 22b to the see-through mirror 23, and an optical path P3 from the see-through mirror 23 to the pupil position PP are arranged so as to be folded back twice in a Z shape. As a result, the normal line at the central location of the see-through mirror 23 where the optical axis AX intersects forms an angle of θ, which is 40° to 50°, with respect to the Z direction. In this imaging optical system 20, the optical elements 21, 22, and 23 constituting the first display device 100A are arranged so that height positions thereof are changed in the longitudinal direction, and thus an increase in the width of the first display device 100A can be prevented. Further, the optical path is folded back by reflection on the prism mirror 22 and the like and thus the optical paths P1 to P3 are arranged so as to be folded back twice in a Z shape. Since the optical paths P1 and P3 are relatively close to the horizontal, the imaging optical system 20 can be miniaturized also in the up-down direction and the front-rear direction. In addition, the inclination angle θ at the central location of the see-through mirror 23 is 40° to 50°, and thus when the inclination of the optical path P3 corresponding to the line of sight is constant, the inclination of the optical path P2 with respect to the Z-axis is 70° to 90°, which facilitates reduction of the thickness of the virtual image display device 100 in the Z direction.

In the imaging optical system 20, the optical path P1 from the projection lens 21 to the inner reflection surface 22b extends in a slightly diagonally upward direction or in a direction substantially parallel to the Z direction toward the rear with the location of the eyepoint as a reference. The optical path P2 from the inner reflection surface 22b to the see-through mirror 23 extends obliquely downward toward the front. When the horizontal plane direction (XZ plane) is used as a reference, the inclination of the optical path P2 is larger than the inclination of the optical path P1. The optical path P3 from the see-through mirror 23 to the pupil position PP extends in a slightly diagonally upward direction or in a direction substantially parallel to the Z direction toward the rear. In the illustrated example, a part of the optical axis AX corresponding to the optical path P3 is at substantially −10° with respect to the Z direction when a downward direction is assumed to be negative. That is, the partially transmissive mirror 123 reflects the image light ML such that the optical axis AX or the optical path P3 is directed upward at a predetermined angle, that is, upward at substantially 10°. As a result, an emission optical axis EX that is an extension of a part of the optical axis AX corresponding to the optical path P3 is inclined and extends downward at substantially 10° with respect to a central axis HX that is parallel to the +Z direction. This is because a line of sight of a human being is stable in a slightly lowered eye state in which the line of sight is inclined downward by substantially 10° with respect to a horizontal direction. The central axis HX that extends in the horizontal direction with respect to the pupil position PP is defined on the assumption of a case in which the wearer US wearing the first display device 100A relaxes in an upright posture and faces the front and gazes in the horizontal direction or at the horizontal line.

Note that the entire optical path in the imaging optical system 20 is not limited to a path including the three optical paths P1, P2, and P3 formed into a Z shape as illustrated in the drawing, and can be changed to various optical paths including two or four or more optical paths. In the illustrated example, the first optical path P1 and the last optical path P3 are closer to be horizontal than the intermediate optical path P2, but the angles of the optical paths P1, P2, and P3 can also be set to various angles in consideration of use of the virtual image display device 100 and the like. However, it is typically desirable that the last optical path P3 be set in consideration of the line of sight as described above. The posture of the partially transmissive mirror 123 is affected by the angle setting of the intermediate optical path P2 and the angle setting of the last optical path P3, particularly in the central portion through which the optical axis AX passes.

In the imaging optical system 20, the projection lens 21 includes a first lens 21o, a second lens 21p, and a third lens 21q. The projection lens 21 receives the image light ML emitted from the display element 11 and makes the image light ML incident on the prism mirror 22. The projection lens 21 focuses the image light ML emitted from the display element 11 into a state close to a parallel luminous flux. The optical surfaces, that is, the incident surfaces and the exit surfaces of the first lens 21o, the second lens 21p, and the third lens 21q constituting the projection lens 21 are free form surfaces or aspheric surfaces, are asymmetric with respect to the optical axis AX in the longitudinal direction that is parallel to the YZ plane and intersects the optical axis AX, and are symmetric with respect to the optical axis AX in the transverse direction or the X direction. The first lens 21o, the second lens 21p, and the third lens 21q may be formed of, for example, resin, but may also be formed of glass. An antireflection film can be formed at each optical surface of the first lens 21o, the second lens 21p, and the third lens 21q constituting the projection lens 21.

The prism mirror 22 is a refractive and reflective optical member having a function obtained by combining a mirror and a lens, and reflects the image light ML from the projection lens 21 while refracting the image light ML. The prism mirror 22 includes an incident surface 22a corresponding to an incident portion, the inner reflection surface 22b corresponding to a reflection portion, and an exit surface 22c corresponding an exit portion. The prism mirror 22 emits the image light ML incident from the front such that the image light ML is folded back in a direction inclined downward with respect to a direction reverse to an incident direction (a direction of the light source seen from the prism mirror 22). The incident surface 22a, the inner reflection surface 22b, and the exit surface 22c, which are the optical surfaces constituting the prism mirror 22, are asymmetric with respect to the optical axis AX in the longitudinal direction that is parallel to the YZ plane and intersects the optical axis AX and are symmetric with respect to the optical axis AX in the transverse direction or the X direction. The optical surfaces of the prism mirror 22, that is, the incident surface 22a, the inner reflection surface 22b, and the exit surface 22c are, for example, free form surfaces. The incident surface 22a, the inner reflection surface 22b, and the exit surface 22c are not limited to free form surfaces and may be aspheric surfaces. The prism mirror 22 may be formed of, for example, resin, but may also be formed of glass. The inner reflection surface 22b is not limited to one that reflects the image light ML by total reflection, and may be a reflection surface formed of a metal film or a dielectric multilayer film. In this case, a reflection film including a single layer film or multilayer film formed of a metal such as Al or Ag is formed on the inner reflection surface 22b by vapor deposition or the like, or a sheet-shaped reflection film formed of a metal is affixed thereto. Although detailed illustration is omitted, an antireflection film may be formed on the incident surface 22a and the exit surface 22c.

The see-through mirror 23 is a curved plate-shaped reflective optical member serving as a concave surface mirror and allows outside light OL to be partially transmitted therethrough while reflecting the image light ML from the prism mirror 22. The see-through mirror 23 reflects, toward the pupil position PP, the image light ML from the prism mirror 22 disposed in an emission region of the projection optical system 12. The see-through mirror 23 includes a reflection surface 23c and an outside surface 230.

The see-through mirror 23 partially reflects the image light ML and enlarges the intermediate image formed on the light exit side of the prism mirror 22. The see-through mirror 23 is a concave mirror that covers the pupil position PP at which the eye EY or the pupil is located, has a concave shape toward the pupil position PP, and has a convex shape toward the outside. The pupil position PP or its aperture PPA is referred to as an eye point or eye box. The pupil position PP or the aperture PPA corresponds to an exit pupil EP on the exit side of the imaging optical system 20. The see-through mirror 23 is a collimator and converges, to the pupil position PP, the main beams of the image light ML emitted from the respective points at the display surface 11a and spread once by imaging in the vicinity of the exit side of the prism mirror 22 of the projection optical system 12. The see-through mirror 23 as a concave mirror enables an intermediate image (not illustrated) formed at the display element 11, which is the image light generation device, and re-imaged by the projection optical system 12 to be viewed in an enlarged manner. More specifically, the see-through mirror 23 functions in the same manner as a field lens and causes the image light ML from the respective points of the intermediate image (not illustrated) formed in the latter stage of the exit surface 22c of the prism mirror 22 to be incident such that the whole of the image light ML in a collimated state is converted to the pupil position PP. The see-through mirror 23 is disposed between the intermediate image and the pupil position PP and, in view of this point, needs to have an extent equal to or larger than an effective area EA corresponding to the angle of view (the combination of the visual field angles in the up-down and left-right directions with reference to the optical axis AX extending in the front direction of the eye). In the see-through mirror 23, the outer area expanding outside the effective area EA does not directly affect imaging and thus can have any surface shape. However, from the viewpoint of having an appearance like a spectacle lens, it is desirable that its curvature be the same as the curvature of the surface shape of the outer edge of the effective area EA or the outer area continuously change from the outer edge.

The see-through mirror 23 is a semi-transmissive mirror plate having a structure in which the reflective polarizing film 23a is formed on the rear surface of a plate-shaped body 23b. The reflection surface 23c of the see-through mirror 23 is asymmetric with respect to the optical axis AX in the longitudinal direction that is parallel to the YZ plane and intersects the optical axis AX and is symmetric with respect to the optical axis AX in the transverse direction or the X direction. The reflection surface 23c of the see-through mirror 23 is, for example, a free form surface. The reflection surface 23c is not limited to a free form surface and may be an aspheric surface. The reflection surface 23c needs to have an extent equal to or larger than the effective area EA. When the reflection surface 23c is formed in the outer area wider than the effective area EA, visibility is less likely to be different between an outside image from behind the effective area EA and an outside image from behind the outer area.

The reflection surface 23c or the reflective polarizing film 23a of the see-through mirror 23 is formed of a polarizing film reflecting s-polarized light and functions as a reflective polarizer 23p. The polarization axis of the reflective polarizing film 23a is set in the up-down direction. That is, the reflection axis of the reflective polarizing film 23a is set in the left-right direction, and the reflective polarizing film 23a efficiently reflects s-polarized light whose polarization direction is the ±X direction corresponding to the left-right direction with little attenuation, and allows p-polarized light whose polarization direction is the ±Y direction corresponding to the up-down direction to be mostly transmitted therethrough. The transmission axis of the reflective polarizing film 23a is directed in the up-down direction, i.e., the ±Y direction. As a result, an s component of the image light ML is reflected and a p component thereof is transmitted, so that the reflective polarizing film 23a functions like a half mirror for the image light ML. On the other hand, in a case where the outside light OL passes through the polarizing filter 30, the outside light OL is blocked by the see-through mirror 23 when the outside light OL is s-polarized light, and the outside light OL passes through the see-through mirror 23 when the outside light OL is p-polarized light. This enables see-through view of the outside, and enables a virtual image to be superimposed on an outside image. At this time, when the plate-shaped body 23b supporting the reflective polarizing film 23a is as thin as substantially several millimeters or less, a change in magnification of the outside image can be reduced. The plate-shaped body 23b that is a base of the see-through mirror 23 is formed of, for example, resin and may also be formed of glass. The plate-shaped body 23b is formed of the same material as a support plate 61 that supports the plate-shaped body 23b from the surrounding thereof, and that has the same thickness as the support plate 61. The reflective polarizing film 23a is formed of, for example, a dielectric multilayer film including a plurality of dielectric layers having an adjusted film thickness. The reflective polarizing film 23a may be formed by layering and may also be formed by affixing a sheet-shaped reflection film. An antireflection film may be formed at the outside surface 230 of the plate-shaped body 23b.

The polarizing filter 30 allows polarized light of the outside light OL in a first direction, that is, p-polarized light, to be transmitted therethrough and attenuates or blocks polarized light of the outside light OL in a second direction, that is, s-polarized light. In the illustrated example, the polarizing filter 30 has a convex shape toward the outside like the see-through mirror 23. The polarizing filter 30 has a structure in which a transmissive polarizing film 30a is formed on the surface of a plate-shaped body 30b. The transmissive polarizing film 30a is formed of a polarizing film allowing p-polarized light to be transmitted therethrough and functions as a transmissive polarizer 30p. Here, the transmissive polarizer 30p is disposed outside the reflective polarizing film 23a or the reflective polarizer 23p of the see-through mirror 23. That is, the virtual image display device 100 includes the cover member 104 in which the transmissive polarizing film 30a is provided as the transmissive polarizer 30p outside the partially transmissive mirror 123. The polarization axis of the transmissive polarizing film 30a is set in the up-down direction. That is, the transmission axis of the transmissive polarizing film 30a is set in the up-down direction, and thus the transmissive polarizing film 30a allows p-polarized light whose polarization direction is the ±Y direction corresponding to the up-down direction to be efficiently transmitted therethrough with little attenuation and mostly attenuates, by absorption, s-polarized light whose polarization direction is the ±X direction corresponding to the left-right direction. The transmission axis of the transmissive polarizing film 30a is directed in the up-down direction, i.e., the ±Y direction and matches the transmission axis of the reflective polarizing film 23a of the see-through mirror 23. The plate-shaped body 30b supporting the transmissive polarizing film 30a is as thin as substantially 1 mm or less and reduces a change in magnification of the outside image. The plate-shaped body 30b that is the base of the polarizing filter 30 is formed of, for example, resin. The transmissive polarizing film 30a includes a polarizing film obtained by stretching a polymer material containing, for example, an iodide compound or a dye in a specific direction and can be directly formed on the plate-shaped body 30b or can be formed in a sheet shape and attached to the plate-shaped body 30b. The transmissive polarizing film may have a polarization property by applying a liquid material containing a liquid crystal or another absorbing material onto the plate-shaped body 30b and imparting a light distribution characteristic through irradiation with ultraviolet rays in a specific polarization state. An antireflection film may be formed at an inside surface 30i of the plate-shaped body 30b.

In describing the optical path, the image light ML from the display element 11 is incident on the projection lens 21 and is emitted from the projection lens 21 in a state of being substantially collimated. The image light ML that has passed through the projection lens 21 is incident on the prism mirror 22, passes through the incident surface 22a while being refracted, is reflected by the inner reflection surface 22b with a high reflectance of substantially 100%, and is refracted again by the exit surface 22c. The image light ML from the prism mirror 22 is incident on the see-through mirror 23 after once forming an intermediate image and is reflected by the reflection surface 23c with a reflectance of substantially 50% or less. At this time, s-polarized light is mainly reflected and p-polarized light is transmitted. The image light ML reflected by the see-through mirror 23 is incident on the pupil position PP at which the eye EY or pupil of the wearer US is placed. The outside light OL that has passed through the see-through mirror 23 and the support plate 61 therearound is also incident on the pupil position PP. In other words, the wearer US wearing the first display device 100A can observe a virtual image of the image light ML superimposed on the outside image. When the transmittance of the reflection surface 23c of the see-through mirror 23 with respect to p-polarized light is, for example, substantially 50%, and when polarization of the image light ML from the display element 11 is not biased, the p-polarized image light ML that has passed through the see-through mirror 23 also passes through the polarizing filter 30. When the transmittance of p-polarized light through the polarizing filter 30 is 50%, the leakage of the image light ML to the outside can be reduced by 50% by the polarizing filter 30, and the leakage light becomes substantially 25% of the original light.

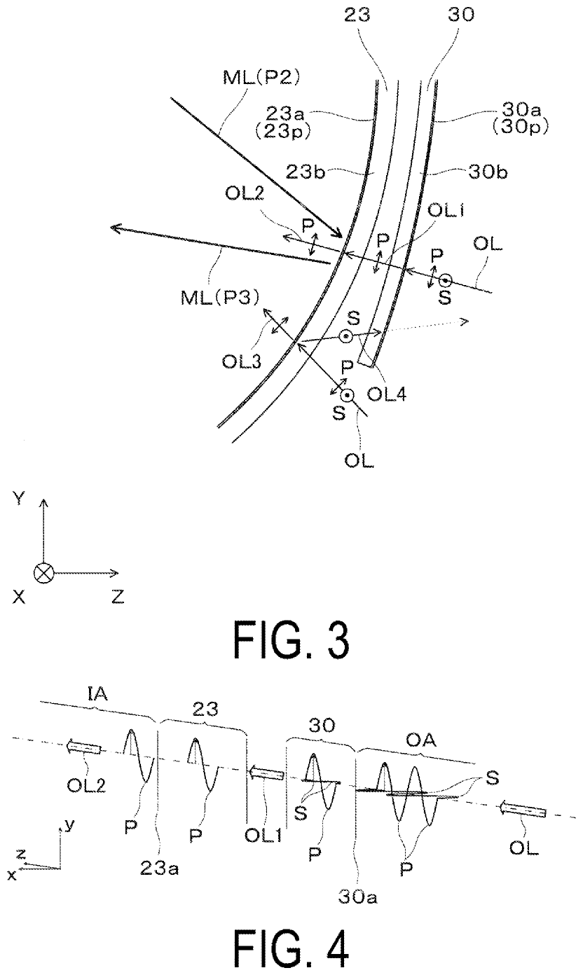

A case where the outside light OL is incident from the outside of the polarizing filter 30 will be described in detail with reference to FIG. 3. The outside light OL includes p-polarized light and s-polarized light. When the outside light OL passes through the transmissive polarizing film 30a of the polarizing filter 30, the s-polarized light is absorbed and the p-polarized light passes therethrough with high transmittance. Here, the polarizing filter 30 is of a transmissive type, and the outside light OL is hardly reflected. Light OL1 that has passed through the transmissive polarizing film 30a is only p-polarized light, and passes through the reflective polarizing film 23a of the see-through mirror 23 with high transmittance. Light OL2 that has passed through the reflective polarizing film 23a is incident on the eye EY of the wearer US. Accordingly, the wearer US can observe an image corresponding to the image light ML superimposed on the outside image corresponding to the light OL2. In this case, the transmittance of the outside light OL through the polarizing filter 30 and the see-through mirror 23 can be set to substantially 50%. On the other hand, since the outside light OL is hardly reflected by the polarizing filter 30, it is possible to suppress a phenomenon in which an outside light pattern is projected, being reduced in size, on the convex surface of the polarizing filter 30 and is seen in a glittered manner. Accordingly, it is possible not only to prevent uncomfortable feeling in appearance where a high-luminance pattern is projected when the HMD 200 or the virtual image display device 100 is worn, but also to facilitate eye contact between the wearer and a person facing the wearer. Even when the transmission axis of the reflective polarizer 23p and the transmission axis of the transmissive polarizer 30p extend in the up-down direction, and the polarizing filter 30 slightly reflects s-polarized light in the left-right direction or the transverse direction or allows the s-polarized light to be transmitted therethrough, it is possible to effectively suppress glittering of the surface of the polarizing filter 30 when the outside light OL includes a large amount of horizontally polarized light, like light reflected on a water surface.

When the outside light OL is directly incident on a lower portion of the see-through mirror 23, the p-polarized light of the outside light OL passes through the reflective polarizing film 23a of the see-through mirror 23 with high transmittance, and the s-polarized light of the outside light OL is reflected by the reflective polarizing film 23a with relatively high reflectance. P-polarized light OL3 transmitted through the reflective polarizing film 23a is incident on the eye EY of the wearer US. On the other hand, when s-polarized light OL4 reflected by the reflective polarizing film 23a is incident on the polarizing filter 30 from the rear, the light is absorbed by the transmissive polarizing film 30a and is not emitted to the outside.

FIG. 4 is a diagram for specifically describing an electric field of the outside light OL passing through the polarizing filter 30 and the see-through mirror 23 illustrated in FIG. 3. In the drawing, x, y, and z are local coordinates in which the traveling direction of the outside light OL is a reference direction, the ±x direction indicates the left-right direction, the ±y direction indicates the up-down direction, and the +z direction indicates the propagation direction of light. When the outside light OL illustrated in FIG. 3 propagates in the −Z direction, the +x direction corresponds to the −X direction, the +y direction corresponds to the +Y direction, and the +z direction corresponds to the −Z direction. When polarization is not biased, the outside light OL includes a linearly polarized light component having an amplitude parallel to the yz plane, that is, p-polarized light in the up-down direction, and a linearly polarized light component having an amplitude parallel to the xz plane, that is, s-polarized light in the left-right direction. When the outside light OL is incident on the polarizing filter 30 from an outer space OA, the light OL1 that passes through the polarizing filter 30 and that is to be emitted in the +z direction is only p-polarized light in the up-down direction or includes p-polarized light in the up-down direction and weak s-polarized light in the left-right direction. When the light OL1 that has passed through the polarizing filter 30 is incident on the see-through mirror 23, the light OL2 passing through the see-through mirror 23 and emitted to an inner space IA is only p-polarized light in the up-down direction. Even when weak s-polarized light is reflected in the −z direction by the see-through mirror 23, the light is mostly absorbed by the polarizing filter 30.

Returning to FIG. 2, the display control device 88 is a display control circuit and controls a display operation of the display element 11 by outputting a drive signal corresponding to an image to the display element 11. The display control device 88 includes, for example, an IF circuit and a signal processing circuit and causes the display element 11 to display a two-dimensional image according to image data or an image signal received from the outside. The display control device 88 may include a main substrate that controls the first display device 100A and the second display device 100B. The main substrate may have an interface function that communicates with the user terminal 90 illustrated in FIG. 1 and performs signal conversion on a signal received from the user terminal 90, and an integrated function that coordinates the display operation of the first display device 100A and the display operation of the second display device 100B. The HMD 200 or the virtual image display device 100 that does not include the display control device 88 or the user terminal 90 is also a virtual image display device.

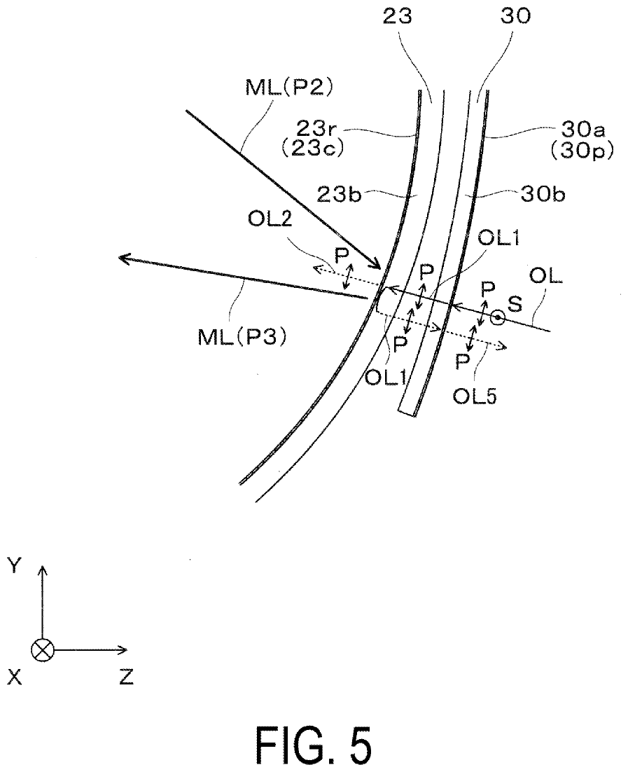

FIG. 5 is a diagram for describing a modified example of the see-through mirror 23 illustrated in FIG. 3 and the like. In this case, a semi-transmissive mirror film 23r is formed at the see-through mirror 23 as the reflection surface 23c. The semi-transmissive mirror film 23r has reflective and transmissive characteristics of a non-polarization type and is formed of a single layer film or a multilayer film made of a metal such as Al and Ag and having an adjusted film thickness. The semi-transmissive mirror film 23r may be formed of, for example, a dielectric multilayer film including a plurality of dielectric layers having an adjusted film thickness. In this case, light OL1 from the outside that has passed through the polarizing filter 30 partially passes through the semi-transmissive mirror film 23r and is partially reflected. When the transmittance of the semi-transmissive mirror film 23r is 50%, light OL2 passing through the see-through mirror 23 and emitted toward the pupil position PP has an intensity of substantially ¼ of original outside light OL. Further, light OL5 reflected by the semi-transmissive mirror film 23r, passing through the polarizing filter 30, and emitted toward the outside also has an intensity of substantially ¼ of the original outside light OL. When polarization of the image light ML from the display element 11 is not biased, p-polarized image light ML having passed through the see-through mirror 23 also passes through the polarizing filter 30, but s-polarized image light ML is blocked by the polarizing filter 30. As a result, it is possible to suppress leakage of the image light ML toward the outside.

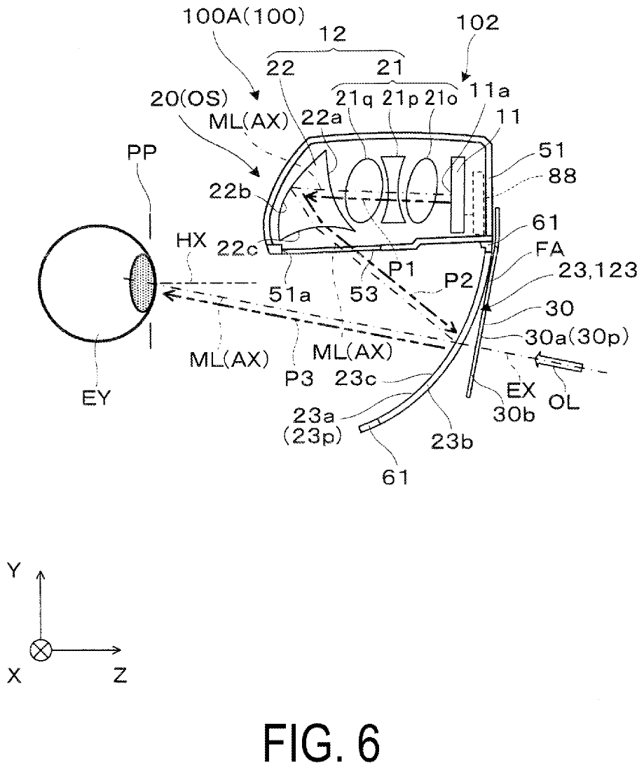

FIG. 6 is a diagram for describing a modified example of the polarizing filter 30 illustrated in FIG. 3 and the like. The polarizing filter 30 has a flat-plate area FA. The transmissive polarizing film 30a is formed in the flat-plate area FA. In this case, the transmissive polarizing film 30a can be easily formed into a sheet shape and attached to the plate-shaped body 30b.

According to the virtual image display device 100 of the first embodiment described above, the transmissive polarizer is disposed outside the partially transmissive mirror 123, and thus the transmissive polarizer 30p suppresses reflection of polarized light of outside light OL in a specific direction or a direction orthogonal thereto while allowing the polarized light of the outside light OL in the specific direction to pass through the partially transmissive mirror 123 and to be incident on the pupil position PP. Thus, it is possible to suppress a situation in which an outside light pattern is projected on the surface of the partially transmissive mirror 123 and seen in a glittered manner. This can facilitate eye contact while preventing uncomfortable feeling in appearance when the virtual image display device 100 is worn.

In particular, in the first embodiment, the partially transmissive mirror 123 includes the reflective polarizer 23p, and the transmissive polarizer 30p is disposed outside the reflective polarizer 23p, the transmission axis of the transmissive polarizer 30p matching the transmission axis of the reflective polarizer 23p. In this case, it is possible to allow the polarized light of the outside light in the specific direction to be transmitted through the partially transmissive mirror 123 without waste.

In the above embodiment, the transmission axis of the reflective polarizer 23p and the transmission axis of the transmissive polarizer 30p are parallel to the up-down direction, i.e., the ±Y direction, but matching of the transmission axis of the reflective polarizer 23p and the transmission axis of the transmissive polarizer 30p means that the transmission axis of the reflective polarizer 23p and the transmission axis of the transmissive polarizer 30p form an angle of ±45° or less. That is, even when the transmission axis of the reflective polarizer 23p and the transmission axis of the transmissive polarizer 30p form an angle of 45° therebetween, the transmission axes of both polarizers match each other. However, from the viewpoint of facilitating observation of the outside light OL, the outside light OL can be efficiently incident on the pupil position PP by setting the angle between the transmission axis of the reflective polarizer 23p and the transmission axis of the transmissive polarizer 30p to be ±20° or less, preferably ±10° or less. Furthermore, in the above embodiment, the transmission axis of the reflective polarizer 23p and the transmission axis of the transmissive polarizer 30p are parallel to the up-down direction, that is, the ±Y direction, but the transmission axis of the reflective polarizer 23p and the transmission axis of the transmissive polarizer 30p may be parallel to the left-right direction, that is, the ±X direction.

### Second Embodiment

A virtual image display device according to a second embodiment of the present disclosure will be described below. The virtual image display device according to the second embodiment is a partial modification of the virtual image display device according to the first embodiment and description of common parts will be omitted.

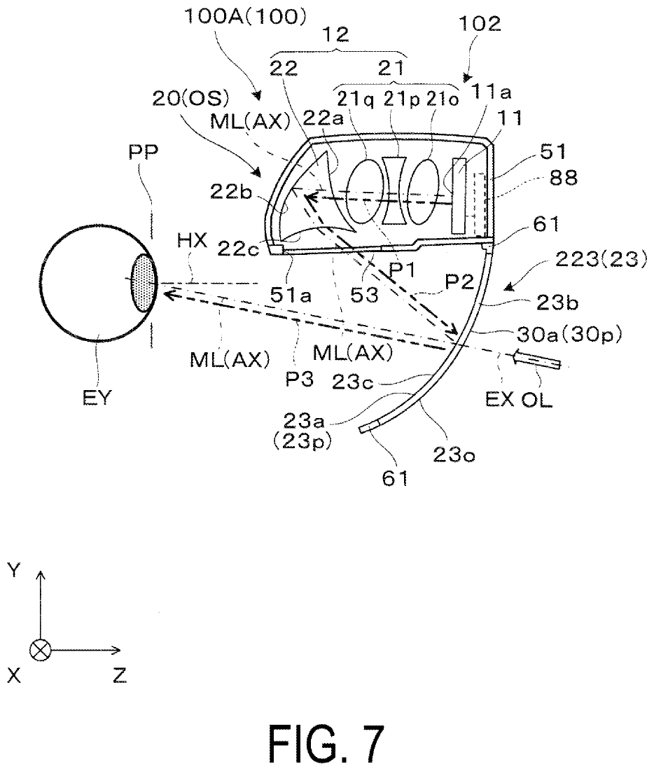

FIG. 7 is a side cross-sectional view for describing an optical structure of the first display device 100A of the virtual image display device according to the second embodiment. In this case, the see-through mirror 23 is one in which the polarizing filter 30 (see FIG. 2) of the first embodiment is integrally incorporated. Specifically, the reflective polarizing film 23a is formed on the side of the plate-shaped body 23b facing the eye EY, and the transmissive polarizing film is formed on the side of the plate-shaped body 23b facing the outside. In the see-through mirror 23 or a partially transmissive mirror 223, the reflective polarizing film 23a provided on the inner side of the plate-shaped body 23b that is the base functions as the reflective polarizer 23p, and the transmissive polarizing film 30a attached to the outer side of the plate-shaped body 23b that is the base functions as the transmissive polarizer 30p.

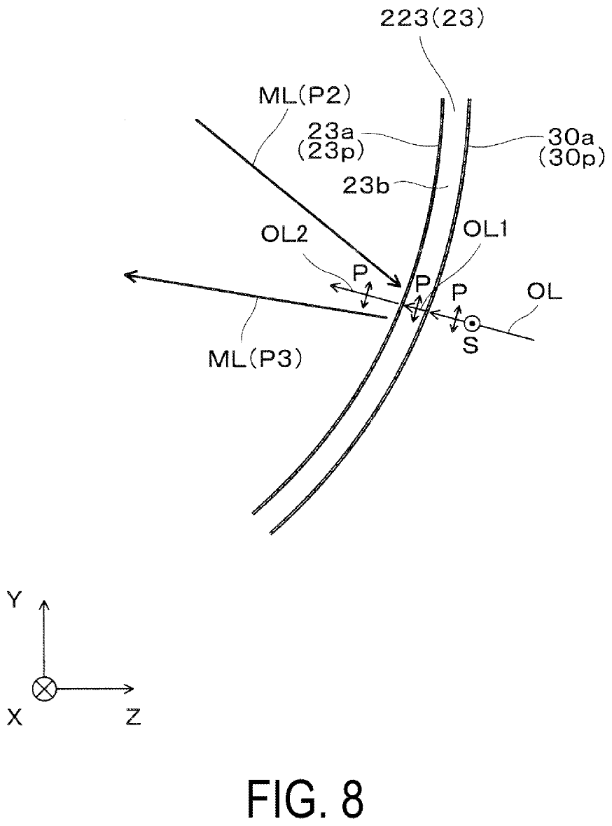

As illustrated in FIG. 8, in a case where outside light OL is incident from the outside of the see-through mirror 23 or the partially transmissive mirror 223 in the virtual image display device according to the second embodiment, when the outside light OL passes through the transmissive polarizing film of the polarizing filter 30, s-polarized light is absorbed and p-polarized light passes therethrough with high transmittance. That is, the outside light OL is hardly reflected by the polarizing filter 30. As in the second embodiment, by forming the reflective polarizing film 23a at the surface of the see-through mirror 23, the partially transmissive mirror 223 and the transmissive polarizer 30p are integrated, and the structure of the virtual image display device 100 is simplified. As in the first embodiment, light OL1 that has passed through the transmissive polarizing film 30a of the see-through mirror 23 is only p-polarized light and passes through the reflective polarizing film 23a with high transmittance. Light OL2 that has passed through the reflective polarizing film 23a is incident on the eye EY of the wearer US.

### Third Embodiment

A virtual image display device according to a third embodiment of the present disclosure will be described below. The virtual image display device according to the third embodiment is a partial modification of the virtual image display device according to the first embodiment and description of common parts will be omitted.

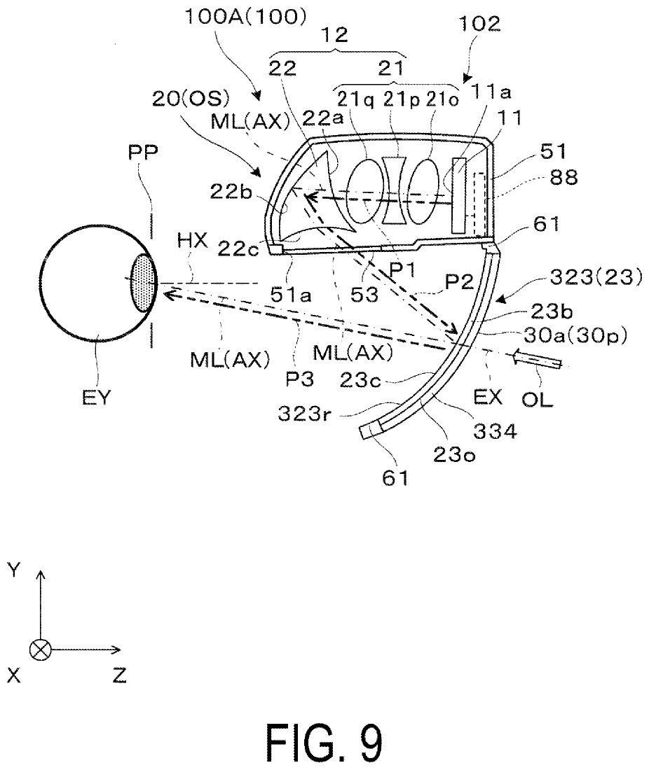

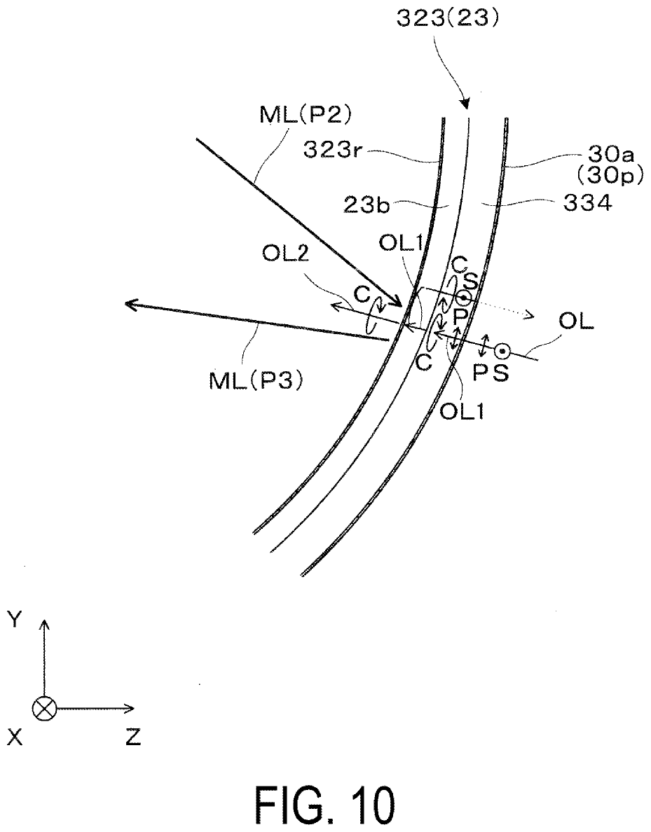

FIG. 9 is a side cross-sectional view for describing an optical structure of the first display device 100A of the virtual image display device according to the third embodiment. FIG. 10 is a partially enlarged cross-sectional view for describing the see-through mirror 23. In this case, the see-through mirror 23 or a partially transmissive mirror 323 includes the plate-shaped body 23b that is the base, a semi-transmissive mirror film 323r provided on the side of the plate-shaped body 23b facing the eye EY, a λ/4 wave plate 334 provided on the side of the plate-shaped body 23b facing the outside, and the transmissive polarizing film 30a formed on the side of the λ/4 wave plate 334 facing the outside. The λ/4 wave plate 334 is disposed between the semi-transmissive mirror film 323r and the transmissive polarizing film 30a that is the transmissive polarizer 30p. The semi-transmissive mirror film 323r has reflective and transmissive characteristics of a non-polarization type and is formed of, for example, a single layer film or a multilayer film made of a metal such as Al and Ag and having an adjusted film thickness. The principal axis of the λ/4 wave plate 334 is set, for example, in a direction between the −X direction and the +Y direction and forms an angle of 45° with respect to both directions. In this case, the transmissive polarizer 30p and the λ/4 wave plate 334 function as a circular polarizing filter, and even when outside light OL is incident on the partially transmissive mirror 323 via the transmissive polarizer 30p and is reflected by the semi-transmissive mirror film 323r on the rear surface to form backwardly reflected light, passing of such reflected light through the transmissive polarizer 30p is suppressed. That is, when the outside light OL is incident from the outside of the see-through mirror 23, the outside light OL becomes only p-polarized light by passing through the transmissive polarizing film 30a. Light OL1 that has passed through the transmissive polarizing film 30a becomes circularly polarized light when passing through the λ/4 wave plate 334 and is reflected by the semi-transmissive mirror film 323r. Light OL1′ reflected by the semi-transmissive mirror film 323r becomes s-polarized light when passing through the λ/4 wave plate 334 again and thus is absorbed by the transmissive polarizing film 30a and is not emitted to the outside.

Of the light OL1 that has passed through the transmissive polarizing film 30a, the circularly polarized light that has passed through the λ/4 wave plate 334, has been incident on the semi-transmissive mirror film 323r, and has partially passed through the semi-transmissive mirror film 323r is incident on the pupil position PP as the light OL2.

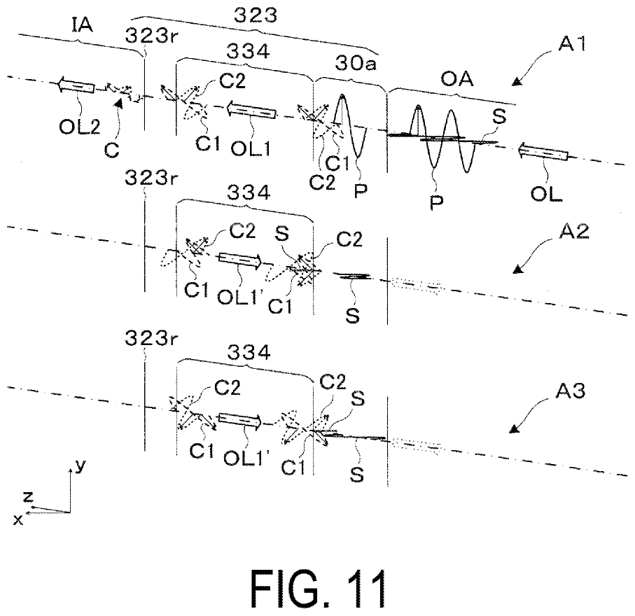

FIG. 11 is a diagram for specifically describing an electric field of the outside light OL passing through the see-through mirror 23 or the partially transmissive mirror 323 illustrated in FIG. 10. As illustrated in an area A1 in FIG. 11, when the outside light OL is incident on the partially transmissive mirror 323, the light OL1 passing through the transmissive polarizing film 30a and emitted in the +z direction becomes p-polarized light in the up-down direction. The p-polarized light OL1 is incident on the λ/4 wave plate 334, thereby including a first component C1 parallel to the fast-axis and a second component C2 parallel to the slow-axis. When the light OL1 passes through the λ/4 wave plate 334, a phase shift of π/2 occurs between the first component C1 and the second component C2 due to the effect of birefringence, so that the light OL1 becomes circularly polarized light. The light OL1 having passed through the λ/4 wave plate 334 is incident on the semi-transmissive mirror film 323r and is partially transmitted therethrough. Light OL2 passing through the semi-transmissive mirror film 323r and emitted to the inner space IA is circularly polarized light C.

As illustrated in an area A2 in FIG. 11, since the light OL1′ reflected by the semi-transmissive mirror film 323r is phase-shifted by n and becomes s-polarized light when traveling backward through the λ/4 wave plate 334, the light OL1′ is absorbed when passing through the transmissive polarizing film 30a and is not emitted to the outer space OA. In the area A2 in FIG. 11, the phase of the electromagnetic wave is not inverted by reflection on the semi-transmissive mirror film 323r, but even in a case where the phase of the electromagnetic wave is inverted by reflection on the semi-transmissive mirror film 323r as illustrated in an area A3 in FIG. 11, the light OL1′ reflected on the semi-transmissive mirror film 323r similarly becomes s-polarized light when traveling backward through the λ/4 wave plate 334 and is not emitted to the outer space OA.

In the example illustrated in FIG. 10, the semi-transmissive mirror film 323r is formed on the rear surface of the plate-shaped body 23b, but the plate-shaped body 23b may be omitted and the semi-transmissive mirror film 323r may be formed on the rear surface of the λ/4 wave plate 334.

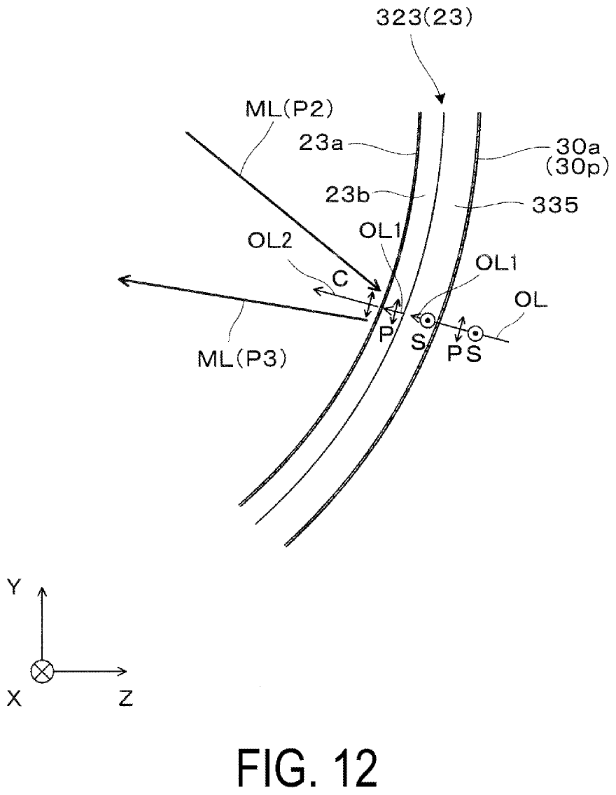

FIG. 12 is a diagram for describing a modified example of the see-through mirror 23 illustrated in FIG. 10 and the like. In this case, the see-through mirror 23 or the partially transmissive mirror 323 includes the plate-shaped body 23b, the reflective polarizing film 23a, a λ/2 wave plate 335, and the transmissive polarizing film 30a. The transmission axis of the transmissive polarizing film 30a is directed in the left-right direction. Accordingly, light OL1 passing through the transmissive polarizing film 30a and emitted in the +z direction becomes p-polarized light due to the effect of birefringence when passing through the λ/2 wave plate 335. The light OL1 having passed through the λ/2 wave plate 335 is mostly transmitted through the reflective polarizing film 23a and is emitted as light OL2 to the inside of the see-through mirror 23. Thus, outside light OL is hardly reflected by the see-through mirror 23.

### Fourth Embodiment

A virtual image display device according to a fourth embodiment of the present disclosure will be described below. The virtual image display device according to the fourth embodiment is a partial modification of the virtual image display device according to the first embodiment and description of common parts will be omitted.

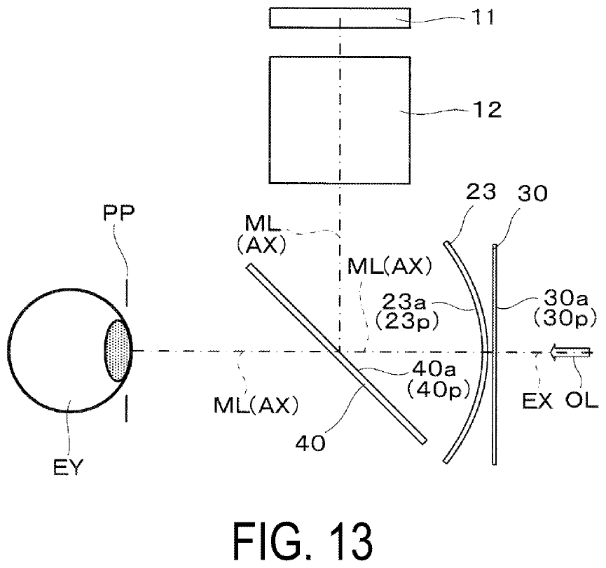

As illustrated in FIG. 13, the virtual image display device 100 according to the fourth embodiment includes the display element 11, the imaging optical system 20, and the polarizing filter 30. The imaging optical system 20 includes the projection optical system 12, a half mirror 40, and the see-through mirror 23. The half mirror 40 is obtained by forming a mirror film 40a including a semi-transmissive reflection layer on a parallel flat plate. The mirror film 40a has a reflectance of substantially 50% with respect to the image light ML. The reflective polarizing film 23a, i.e., the reflective polarizer 23p is formed at the see-through mirror 23, and the transmissive polarizing film 30a, i.e., the transmissive polarizer 30p is formed at the polarizing filter 30. The mirror film 40a of the half mirror 40 can be, for example, a reflective polarizing film, that is, a reflective polarizer 40p.

In the virtual image display device 100, image light ML from the display element 11 is once imaged through the projection optical system 12, is reflected by the half mirror and is incident on the see-through mirror 23. S-polarized light of the image light ML incident on the see-through mirror 23 is reflected, is collimated, passes through the half mirror and is incident on the pupil position PP.

Also in this case, as in the first embodiment and the like, since outside light OL is hardly reflected by the polarizing filter 30, it is possible to suppress a phenomenon in which an outside light pattern is projected on the convex surface of the polarizing filter 30 and is seen in a glittered manner.

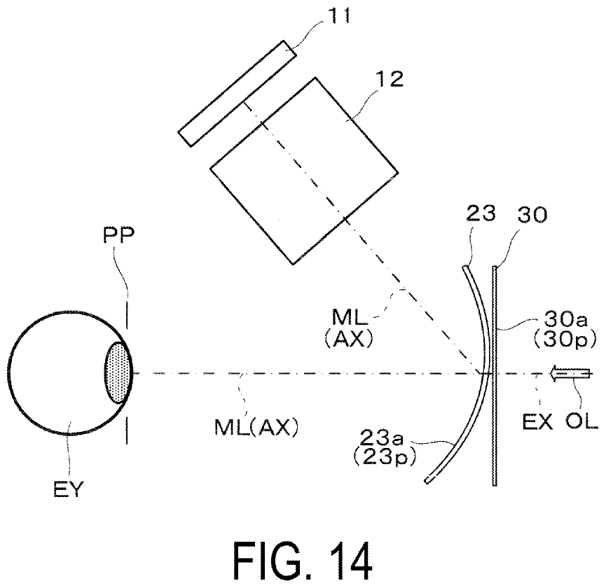

FIG. 14 is a diagram for describing a modified example of the virtual image display device 100 according to the fourth embodiment illustrated in FIG. 13. In this case, the half mirror 40 is omitted, and the image light ML having passed through the projection optical system 12 is directly incident on the see-through mirror 23. The reflective polarizing film 23a of the see-through mirror 23 may be a hologram mirror.

### Fifth Embodiment

A virtual image display device according to a fifth embodiment of the present disclosure will be described below. The virtual image display device according to the fifth embodiment is a partial modification of the virtual image display device according to the first embodiment and description of common parts will be omitted.

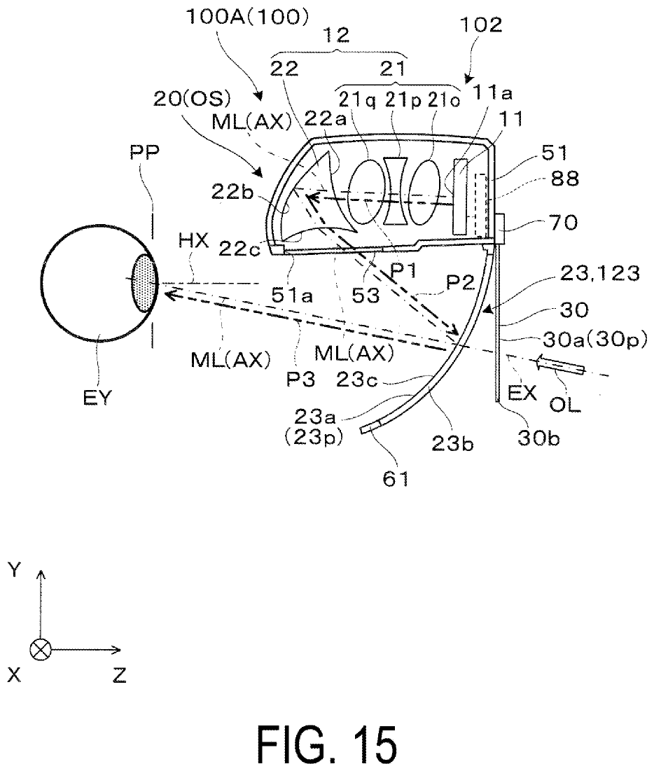

As illustrated in FIG. 15, the virtual image display device 100 according to the fifth embodiment includes a rotation mechanism 70 rotating the polarizing filter 30 around the Z-axis. The rotation axis of the polarizing filter 30 is set to be perpendicular to the tangential plane at the central portion of the polarizing filter 30. Adjusting the rotation angle of the polarizing filter 30 can adjust the angular relationship between the transmission axis of the reflective polarizing film 23a and the transmission axis of the transmissive polarizing film 30a, which enables adjustment of the transmittance of the polarizing filter 30 with respect to the outside light OL.

### MODIFIED EXAMPLES AND OTHERS

Although the present disclosure has been described with reference to the above embodiments, the present disclosure is not limited to the above embodiments and can be implemented in various modes without departing from the spirit of the disclosure. For example, the following modifications are possible.

A depolarizing film can be provided on the surface of the polarizing filter 30 facing the outside. In this case, even when a display utilizing polarized light is present on the outside and the absorption axis of the transmissive polarizing film 30a matches the polarization direction of display light of such a display, the display contents of this type of display can be observed through the virtual image display device 100.

The transmissive polarizing film 30a of the polarizing filter 30 is not limited to a film having a characteristic of an entirely uniform extinction ratio, but may have a distribution pattern of an extinction ratio.

In the description above, the virtual image display device 100 is assumed to be mounted on the head and used, but the virtual image display device 100 described above may also be used as a hand-held display not mounted on the head and viewed into like a pair of binoculars. In other words, the head-mounted display also includes a hand-held display in the present disclosure.

A virtual image display device according to a specific aspect includes an image light generation device, a projection optical system on which image light from the image light generation device is incident, and a partially transmissive mirror configured to partially reflect the image light from the projection optical system toward a pupil position, wherein a transmissive polarizer is disposed outside the partially transmissive mirror.

In the above virtual image display device, the transmissive polarizer is disposed outside the partially transmissive mirror, and thus the transmissive polarizer suppresses reflection of polarized light of the outside light in a specific direction and in a direction orthogonal thereto while allowing the polarized light of the outside light in the specific direction to be transmitted through the partially transmissive mirror and to be incident on the pupil position. Thus, it is possible to suppress a phenomenon in which an outside light pattern is projected on the surface of the partially transmissive mirror and seen in a glittered manner. This can facilitate eye contact while preventing uncomfortable feeling in appearance when the virtual image display device is worn.

In a specific aspect, the partially transmissive mirror includes a reflective polarizer, and the transmissive polarizer is disposed outside the reflective polarizer, the transmissive polarizer having a transmission axis matching a transmission axis of the reflective polarizer. In this case, it is possible to allow polarized light of the outside light in a specific direction to be transmitted through the partially transmissive mirror without waste.

In a specific aspect, a cover member provided with a transmissive polarizing film as the transmissive polarizer is provided outside the partially transmissive mirror. In this case, the cover member also functioning as a support for the transmissive polarizing film is provided outside the partially transmissive mirror, in addition to the partially transmissive mirror.

In a specific aspect, in the partially transmissive mirror, the reflective polarizer is a reflective polarizing film provided on an inside of a base, and the transmissive polarizer is a transmissive polarizing film attached to an outside of the base. In this case, the partially transmissive mirror and the transmissive polarizer are integrated, and the structure of the virtual image display device can be simplified.

In a specific aspect, the partially transmissive mirror includes a semi-transmissive mirror film, and a λ/4 wave plate is disposed between the semi-transmissive mirror film and the transmissive polarizer. In this case, the transmissive polarizer and the λ/4 wave plate function as a circular polarizing filter, and even when outside light is incident on the partially transmissive mirror via the transmissive polarizer, it is possible to suppress a situation in which reflected light reflected by the partially transmissive mirror and traveling backward passes through the transmissive polarizer.

In a specific aspect, the transmissive polarizer is a transmissive polarizing film attached to an outside of the λ/4 wave plate. In this case, the partially transmissive mirror, the λ/4 wave plate, and the transmissive polarizer are integrated, which can simplify the structure of the virtual image display device.

In a specific aspect, a transmission axis of the transmissive polarizer extends in an up-down direction. In this case, when there is a large amount of horizontally polarized light, like reflected light on a water surface, it is possible to effectively suppress glittering of the partially transmissive mirror.

In a specific aspect, the partially transmissive mirror is a concave mirror. In this case, the concave mirror allows an image formed by the image light generation device or an image re-formed by the projection optical system to be viewed in an enlarged manner.

In a specific aspect, the projection optical system includes a first optical member and a second optical member configured to reflect image light from the first optical member. In this case, it is easy to miniaturize the optical system by folding the optical path by reflection.

In a specific aspect, the partially transmissive mirror reflects the image light such that an optical axis is directed upward at a predetermined angle. In this case, it is possible to set the projection direction of the virtual image to be slightly downward so as to correspond to the fact that the line of sight of the human being is stable in a slightly lowered eye state.

What is claimed is:

1. A virtual image display device comprising:
an image light generation device;
a projection optical system on which image light from the image light generation device is incident; and
a partially transmissive mirror configured to partially reflect the image light from the projection optical system toward a pupil position, wherein
a transmissive polarizer is disposed outside the partially transmissive mirror.

2. The virtual image display device according to claim 1, wherein
the partially transmissive mirror includes a reflective polarizer, and
the transmissive polarizer is disposed outside the reflective polarizer, the transmissive polarizer having a transmission axis matching a transmission axis of the reflective polarizer.

3. The virtual image display device according to claim 2, further comprising, outside the partially transmissive mirror, a cover member provided with a transmissive polarizing film as the transmissive polarizer.

4. The virtual image display device according to claim 2, wherein in the partially transmissive mirror, the reflective polarizer is a reflective polarizing film provided on an inside of a base, and the transmissive polarizer is a transmissive polarizing film attached to an outside of the base.

5. The virtual image display device according to claim 1, wherein
the partially transmissive mirror includes a semi-transmissive mirror film, and
a λ/4 wave plate is disposed between the semi-transmissive mirror film and the transmissive polarizer.

6. The virtual image display device according to claim 5, wherein the transmissive polarizer is a transmissive polarizing film attached to an outside of the λ/4 wave plate.

7. The virtual image display device according to claim 1, wherein a transmission axis of the transmissive polarizer extends in an up-down direction.

8. The virtual image display device according to claim 1, wherein the partially transmissive mirror is a concave mirror.

9. The virtual image display device according to claim 1, wherein the projection optical system includes a first optical member and a second optical member configured to reflect image light from the first optical member.

10. The virtual image display device according to claim 1, wherein the partially transmissive mirror reflects the image light such that an optical axis is directed upward at a predetermined angle.
